(19) United States
(12) Patent Application Publication
(10) Pub. No.: US 2006/0060229 A1
(43) Pub. Date: Mar. 23, 2006

(54) Dishwasher with at least one dispenser intended for the provision of a detergent additive

(76) Inventors: Heinrich Gonska, Offenburg (DE); Klaus Padtberg, Offenburg (DE); Dietrich Berner, Waldstetten (DE); Rainer Halter, Durbach (DE); Matthias Kaufmann, Ringsheim (DE)

Correspondence Address: THOMPSON HINE LLP, 2000 COURTHOUSE PLAZA N.E., 10 WEST SECOND STREET, DAYTON, OH, 45402-1758, US

(21) Appl. No.: 11/225,910

(22) Filed: Sep. 14, 2005

(30) Foreign Application Priority Data
Sep. 18, 2004 (DE) 10 2004 045 446.9

(51) Int. Cl. B08B 3/00

(52) U.S. Cl. 134/56 D; 134/93

(57) ABSTRACT

The invention at hand concerns a dishwasher, in particular a commercial front-opening dishwasher, with at least one dispenser intended for the provision of a liquid detergent additive. The one or more dispenser(s) feature(s) a storage container within a dishwasher housing. The dishwasher in accordance with the invention at hand should enable comfortable refilling of the storage container with a detergent additive. In accordance with the invention the dispenser features an inlet part for the storage container, which can be pulled or pivoted out of the dishwasher housing into the filling position.

The invention at hand concerns a dishwasher with at least one dispenser intended for the provision of a liquid detergent additive.

Dispensers of this kind are generally used to store a detergent additive and to dispense a desired amount of detergent additive during the appropriate cycle in a treatment area of the dishwasher.

In the case of commercial dishwashers it is known that detergent additives or processing chemical products are dispensed from large storage containers or units. The storage containers for the detergent additive is located in the case of these dishwashers on the exterior of the dishwasher housing, and the respective detergent additive is fed into the treatment area of the dishwasher via a doser and the respective inlet pipe.

An appliance for the dispensing of liquid detergent additives or processing chemical products from a storage container into a treatment area of a program-controlled dishwasher is known from DE 101 33 108 A1. In addition to the storage container, this appliance also features an primary pumping device, which is attached in a suction-sided alignment to the storage container, an intermediary container with a level measuring

When realized, the intermediary container and the secondary pumping device are integrated into the dishwasher housing. The exchanging of a storage container is intended to be made easier by the attaching of an intermediary container that acts as a sealed buffer. Above all, the scenario should be avoided whereby residues from the previous storage container have to be siphoned off into the new storage container meaning that the user comes into contact with the detergent additive.

Furthermore, commercial dishwashers are known for their storage containers for the detergent additive and the respective dosers being located within the dishwasher housing. Such dishwashers are designed especially for use where the issue of space does not allow for the external attachment of storage containers. A storage container for a rinsing agent and a storage container for a cleaning agent are attached in the case of such commercial dishwashers e.g. in the body of the dishwasher behind a front panel.

The filling of storage containers proves to be relatively difficult here, as the pour-in openings of the storage containers are difficult to access due to their alignment. In some cases the respective storage container must be taken out to be filled and/or a separate funnel be used at the opening. It is often inevitable here that the user comes into contact with the detergent additive when filling the storage container, or that some of the detergent additive is poured away to the side of the storage container. Contact with cleaning agents should be avoided, due above all to the fact that very abrasive chemicals are used in the production of cleaning agents in most cases.

Accordingly, the task that forms the basis for the invention is to make a dishwasher available with a built-in dispenser for the storage and dispensing of a liquid detergent additive, enabling the user to fill the dispenser without any difficulties or hazards.

This task is solved with a dishwasher designed in accordance with claim 1. Advantages in performance are detailed in the sub-claims.

As a basic principle, the invention is suitable for different types of dishwashers, like, for example, hood dishwashers, front-opening dishwashers, dishwashers with sliding baskets, transport dishwashers, but in particular for commercial front-opening dishwashers. All devices that are suitable for supplying a (specifically liquid) detergent additive are described as dispensers. They are designed to store a detergent additive and to dispense this detergent during a particular cycle into a particular area of treatment in the dishwasher. Detergent additives are suitable chemicals or other additives that are added to the washing solution during a particular cycle, particularly cleaning or rinsing agents. All dispensers feature a storage container to store the detergent additive, which is located within the dishwasher housing. The area of treatment for articles to be cleaned is also located within the dishwasher housing.

A fundamental idea behind the invention is based on the notion of making a suitable inlet of a separate inlet part for the pouring in of a detergent additive freely accessible, in order to allow the user to fill the storage container and to avoid having to attach a separate funnel or similar. Therefore the dishwasher, in accordance with the invention at hand, features at least one dispenser with a separate inlet part that can be pulled or pivoted out of the dishwasher housing into a filling position. On this note, designs must be understood, whereby the inlet part is located in a spring-loaded position within the dishwasher housing during normal operation and moves into the filling position with spring force having been touched by the user, as well as other methods of operation.

The inlet part can be pulled out lineally to become a pivotal axis, which is pivoted out, or both pulled and pivoted out. By designing the inlet part to be able to be pulled or pivoted out of the dishwasher housing, for example for filling, the filling position is freely accessible and the detergent additive can be poured into the inlet part with ease.

The dishwasher preferably features a primary dispenser for rinsing agents and a secondary dispenser for cleaning agents. The inlet part for cleaning agents is preferably located in the lower part of the dishwasher, as very abrasive chemicals are used in cleaning agents. The chances of the user coming into contact with the cleaning agent when filling is largely avoided in this way, or at least limited to the area near the ground.

However, both an inlet part for cleaning agents and an inlet part for rinsing agents can be located in the lower part of the dishwasher, and particularly behind the same frontal panel that is located low down.

The inlet part in at least one dispenser preferably features a connecting piece, funnel or similar for the pouring in of the detergent additive. Preferably, no parts are protruding from the dishwasher housing during normal operation of the dishwasher, whilst when filling at least the inlet sticks out from the dishwasher housing so that it is freely accessible.

By attaching the inlet part to the frontal, exterior side of the dishwasher housing with a handle the inlet part can be pulled or pivoted out in comfort. Any kind of handhold or structure that is able to be seized or grasped is suitable as a handle. The inlet part can preferably be pulled or pivoted out from its initial position to its filling position by pulling on the handle. In terms of the inlet part's spring-loaded design as mentioned above, the handle can also take the form of a dimple button, pressure plate or similar and the inlet part is then activated by pressing of these button types.

A channelling surface in the area of the inlet is suitable for guiding the poured-in detergent additive into the direction of the storage container and for avoiding unwanted sideways spillage of the detergent additive. Spillage of the detergent additive within the machine is safeguarded in a functional way by a suitable cover for the inlet part that is especially tightly closed.

At least one dispenser takes on the form of a pull-out drawer in accordance with another advantageous design form. The drawer is able to be pulled out of the dishwasher housing into the filling position. The storage container and the inlet part are, for example, formed as one part, or attached together in one drawer so that the storage container also moves when the drawer with the inlet part is pulled out. It is advantageous to align this type of dispenser in the upper part of the dishwasher.

The idea that the inlet part can be pulled out of the dishwasher housing into the filling position in the form of a drawer in at least one dispenser can also be envisaged, whilst the respective supply container on the other hand is located in a fixed position within the dishwasher housing and is fluidly connected to the inlet part via a flexible adapter. Such a design is particularly advantageous if the storage container has a relatively large volumetric capacity and is therefore heavy enough when full to be difficult to pull out. The flexible adapter can be of tubing or another connecting piece (such as a synthetic moulded shape) between the inlet part and the storage container, whereby it must allow the inlet part to be able to move from its initial position to its filling position.

Costs can be reduced and production simplified if several of the same components are used in a dishwasher. At least two dispensers are preferably envisaged in a dishwasher, whose inlet parts are designed in the same way. It is also possible to design the inlet part of the primary dispenser in the same form with a part, which forms the supply container and the inlet part of a secondary dispenser at the same time. Developing this idea further, both of these parts are essentially designed in a cuboid form and most importantly have a pivotal axis, which lies at roughly one angle to pivot out of the dishwasher housing.

Other advantages arise if the inlet can be closed by means of a closure mechanism in at least one dispenser. The closure mechanism may be optionally positioned as a splashguard when filling. The closure mechanism prevents contaminations entering the dispenser via the inlet. The evaporation of the detergent additive is also prevented by the closure mechanism. A lid or plug can, for example, be used as a closure mechanism. The provision of inlet part lids that open automatically when the inlet part is pulled or pivoted out is particularly advantageous; alternatively, the inner side of the frontal panelling can also form a cover for the respective inlet part.

The attaching of a splashguard is advantageous for preventing the swashing back and forth of the detergent additive between the storage container and the inlet part when filling. This splashguard constricts the cross-sectional area of flow between the storage container and the inlet part into a flow channel located below. The detergent additive is fed when filling from the inlet part via the flow channel below into the storage container.

Due to the fact that the rinsing agent dispenser is relatively light due to its relatively small rinsing agent storage container, it takes the form of a drawer in a functional design that can be pulled forward out of the dishwasher housing into the filling position. Rinsing agents are less harmful and abrasive than cleaning agents, meaning that the rinsing agent dispenser can be aligned above the door, which is located on the front side of the dishwasher housing, and can take advantage of the free space between the area of treatment and the dishwasher housing. The cleaning agent dispenser is preferably located beneath the door, and both dispensers with inlet parts that can be pulled or pivoted out can also be envisaged beneath the door.

The inlet parts of the cleaning agent dispenser and the rinsing agent dispenser are located in the front panelling beneath the loading door of the dishwasher in accordance with another advantageous design. Both inlet parts preferably have a handle and are able to be pivoted out on a pivotal axis into the filling position. Pouring in of a detergent additive is made easier if the inlet parts both feature channelling surfaces, which taper down to the pivotal axis below. The inlet parts both preferably have a groove at the bottom end of each channelling surface, which flows into the respective storage container. Or alternatively tubing or plastic moulded forms are envisaged to connect the inlet part and the storage container.

In another preferable design the bases of each inlet part are located on approximately the same level as the storage containers, meaning that a liquid level check, which gives a sufficiently precise assertion as to the total amount of the respective detergent additive, is possible on one of the two components. Optical monitoring of the liquid level by visually observing the level of the liquid on the front wall of the inlet part is, for example, possible here, as long as the inlet part is designed to be clear or translucent. Traditional automatic and/or electronic means of monitoring and registering the liquid level in liquid containers can also be used here, either as an alternative or an additional function. These include solutions with float and reed contact, devices for compiling guide values, hall sensors etc.

Advantages and expediencies of the invention arise for the rest from the following description of the preferred design examples on the basis of figures.

These show the following:

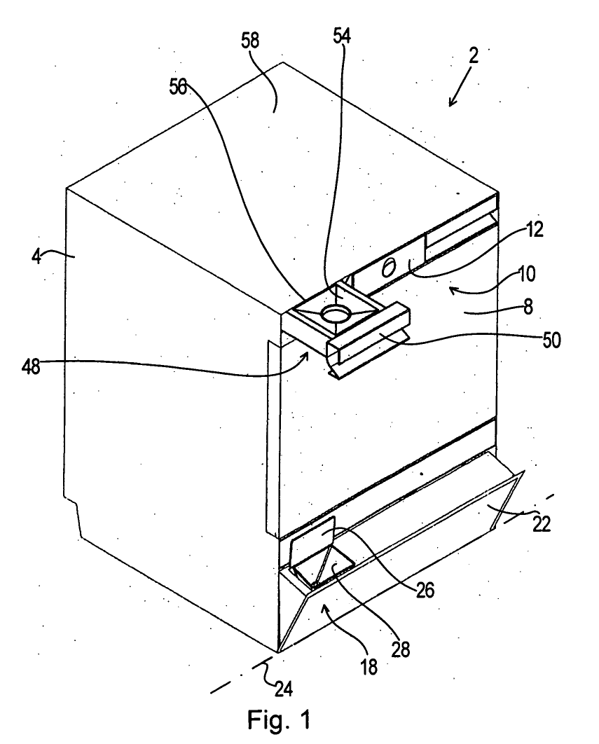

FIG. 1 a perspective view of a dishwasher in accordance with the invention;

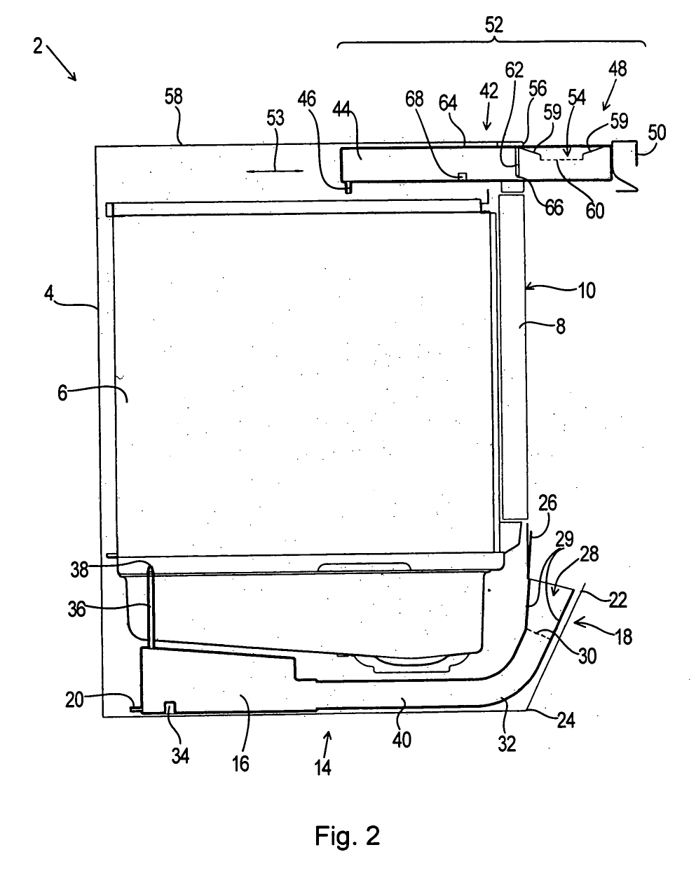

FIG. 2 a cross-sectional view of the dishwasher shown in FIG. 1;

FIG. 3 a view of the front panelling beneath the loading door of a dishwasher in accordance with another preferred design;

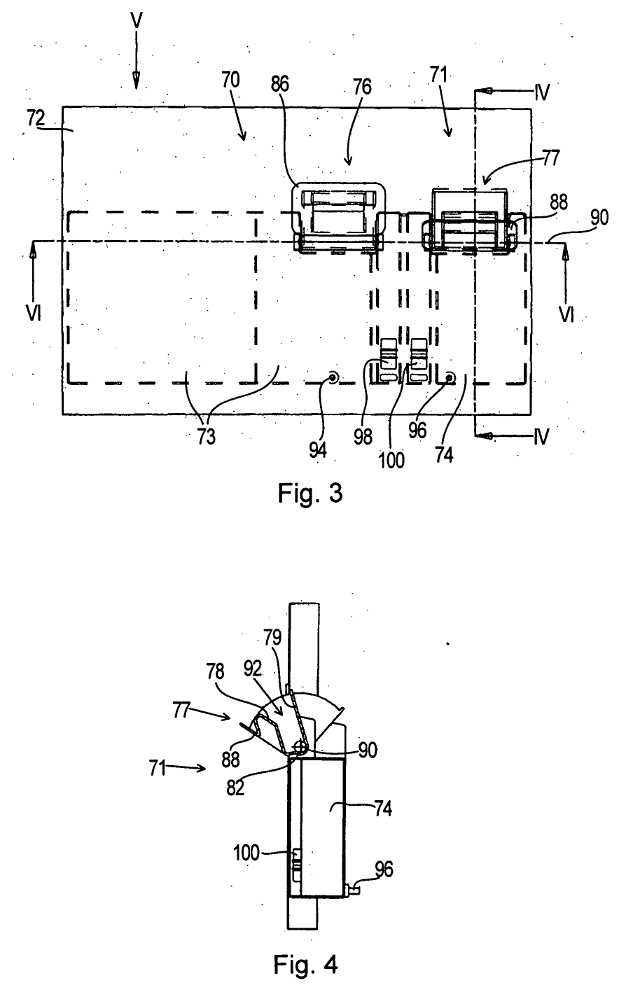

FIG. 4 a cross-sectional view of the dispensers shown in FIG. 3 along the line IV-IV in FIG. 3;

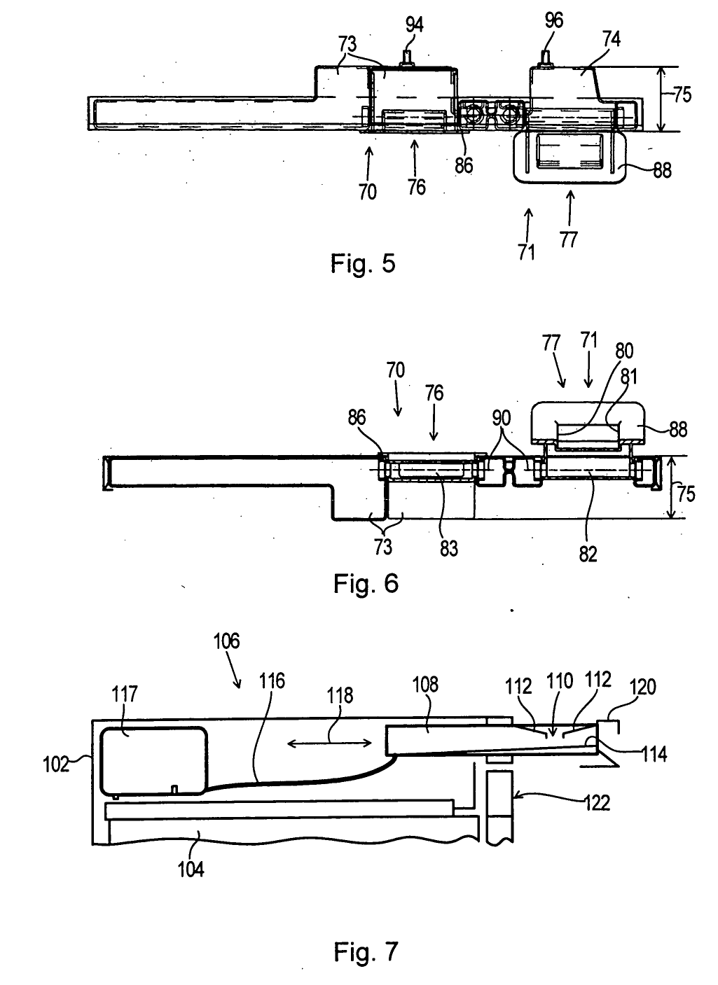

FIG. 5 a plan view from above corresponding to the arrow direction V of the part of the dishwasher shown in FIG. 3;

FIG. 6 a cross-sectional view of the dispensers shown in FIG. 3 along the line VI-VI in FIG. 3;

FIG. 7 a cross-sectional view of the upper section of a dishwasher in accordance with another preferred design;

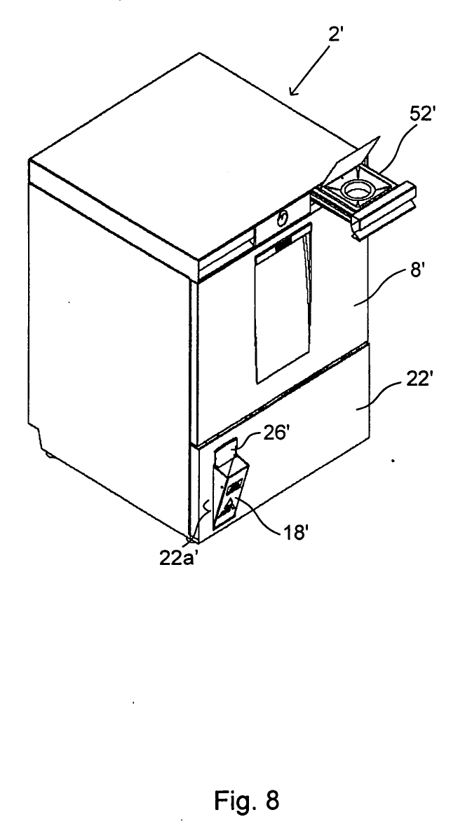

FIG. 8 a perspective view of a dishwasher modified slightly in comparison to the design in FIG. 1;

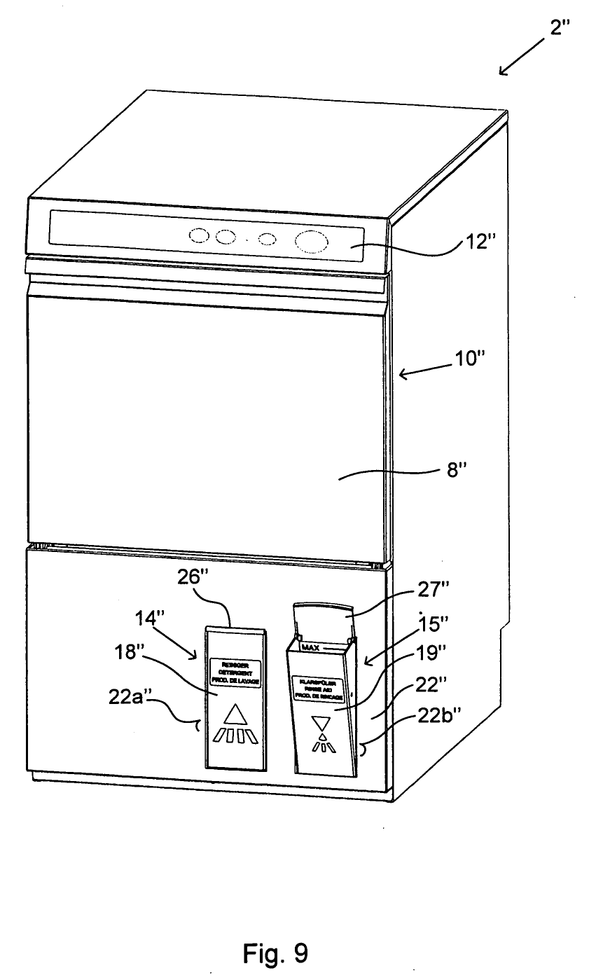

FIG. 9 a schematic, perspective view of a dishwasher in accordance with another design of the invention;

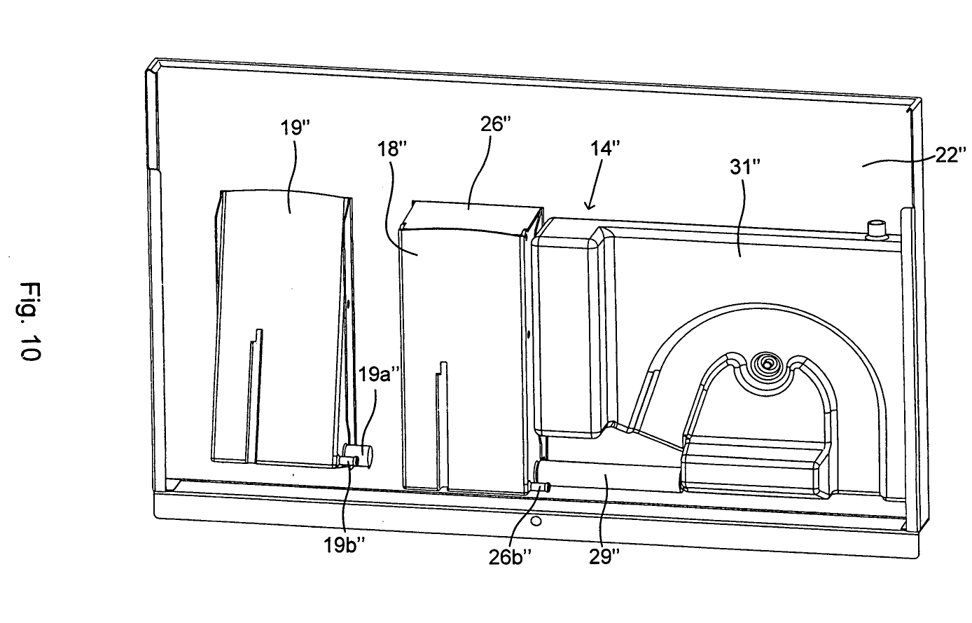

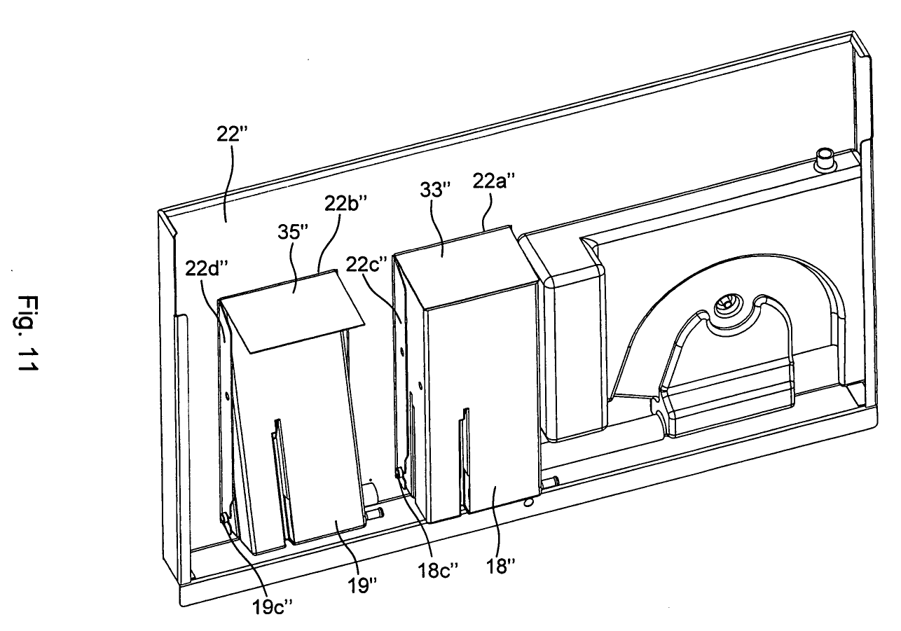

FIG. 10 a perspective rear view of a front panel of the dishwasher in accordance with FIG. 9; as well as

FIG. 11 a perspective rear view of the front panelling in a design modified slightly in comparison to FIG. 10.

FIGS. 1 and 2 show a dishwasher 2 in accordance with the invention at hand. A treatment area 6 for the articles to be cleaned is located within the dishwasher housing 4. By opening a door 8 on the front side 10 of the dishwasher housing 4 the treatment area 6 for the sorting and removing of articles to be cleaned is accessible. By closing the door 8 the treatment area 6 is closed at the same time, meaning that liquid is able to be fed into the treatment area for the cleaning program to be operated.

An operating unit 12 is also envisaged on the front side 10, which is only schematically shown in FIG. 1 and via which the user can set and start a desired cleaning program. In a typical cleaning program several cycles take place, whereby cutlery is cleaned with a cleaning agent solution in at least one cycle and rinsed with a rinsing agent solution in at least one subsequent cycle.

A cleaning agent dispenser is envisaged below the treatment area 6 for the storage and metered dispensing of the cleaning agent. The dispenser 14 features a storage container 16 with a volumetric capacity of 3 to 5 litres and an inlet part 18, which is shown in the filling position in FIGS. 1 and 2. The storage container 16 has an outlet 20, via which cleaning agent can be dosed into the treatment area 6 by means of a doser and pump (not shown). The inlet part 18 has a handle, which is formed from a panel 22 beneath the door 8.

The inlet part 18 is located within the dishwasher housing 4 in its original position and the front surface of the panelling 22 forms a flat, vertical frontal surface together with the closed door 8 and the other parts of the front side 10. In order to fill the storage container 16 with cleaning agent, the upper edge of the front panel 22 or the formed handle is grasped and pulled outwards, so that the panel 22 is pivoted out on a pivotal axis 24 below into a filling position and the inlet part 18 protrudes outwards over the frontal side 10. By opening the lid 26 the inlet 28 becomes accessible, which features a funnel-like channelling surface 29, so that a cleaning agent can be easily poured into the inlet 28 from above.

A particle sieve 30 is envisaged in the inlet 28. A flexible piece of tubing (or moulded part) 32 is located between the inlet 28 and the storage container 16, which allows for the aforementioned pivotal movement of the inlet part 18 between its original position and the filling position. A liquid level display 34 is envisaged in the storage container 16 to register the level of liquid and to signal the need for refilling if necessary. In addition, a ventilation channel 36 with a ventilation opening 38 extends from the storage container 16 upwards, allowing for air to escape when filling the storage container 16, therefore enabling the complete filling of the storage container 16.

The storage container 16 left of the flexible piece of tubing (or moulded part) 32 and the inlet 28 right of this project further upwards than the flow channel 40 of the flexible piece of tubing (or moulded part) 32 located in between, meaning that a swashing back and forth of liquid, in particular on the surface, when filling, is largely prevented.

A dispenser 42 for the storage and metered dispensing of a cleaning agent is located above the treatment area 6 and shown in a filing position in FIGS. 1 and 2. In a similar way to the dispenser for cleaning agent it features a storage container 44, an outlet 46 and an inlet part 48. The amount of rinsing agent required for a cycle is less than the amount of cleaning agent, meaning that a volumetric capacity of 0.6 to 2.5 litres for the storage container 44 is appropriate. Rinsing agent is dosed into the treatment area 6 via the outlet 46 by means of a doser (not shown). The inlet part 48 consists of a handle, which is formed on the upper edge of the inlet part 48. The inlet part 48 of the rinsing agent dispenser 42 forms a drawer 52 together with the storage container 44, which can be moved in and out in the arrow direction 53. In its original position the drawer 52 is pushed so far back that the handle grip 50 forms a flat, vertical frontal surface together with the closed door 8, the panelling 22 and the other parts of the front side 10.

The filling of the rinsing agent dispenser with rinsing agent takes place in a similar way to the filling of the cleaning agent dispenser 14. Firstly the handle grip 50 is grasped and pulled so that the drawer 52, i.e. the inlet part 48 together with the storage container 44, is pulled outwards until the inlet part 48 protrudes out above the other parts of the front side 10. In this filling position an inlet 54 of the inlet part 48 protrudes most significantly over the upper edge 56 of the dishwasher housing top 58, so that rinsing agent can be easily poured into the inlet 54. The inlet 54 features channelling surfaces 59 so that the inlet is tapered downwards from above.

A particle sieve 60 is envisaged in the inlet 54. In addition, a separating wall 62 is located between the storage container 44 and the inlet part 48, which extends from the upper wall 64 of the drawer 52 downwards and frees a flow channel 66 in the lower area of the drawer 52. A splashguard is formed by the separating wall 62, which largely prevents the swashing back and forth of rinsing agent, especially when refilling.

A liquid level display 68 is envisaged in the storage container 44 to register the level of the liquid and to signal the need to refill if necessary. In addition, the storage container 44 also features a ventilation opening (not shown), so that air can escape from the storage container 44 during filling.

The alignment of the dispenser 14 for cleaning agent beneath the treatment area 6 and the dispenser 42 for rinsing agent above the treatment area 6, as shown in FIGS. 1 and 2, results in an efficient space-saving distribution, which also allows for a relatively large volumetric capacity of both storage containers 16 & 44. The location of the cleaning agent dispenser in the lower part of the dishwasher 14 means that the user only has to handle cleaning agent in the area near to the ground, so that the danger of coming into contact with a relatively abrasive cleaning agent, that could be damaging to health, is reduced further.

FIGS. 3 to 6 show another dishwasher design, in which two dispensers 70, 71 for cleaning and rinsing agents are located behind a front panel 72 of the dishwasher housing.

FIG. 3 shows a frontal view of the front panelling 72 from the exterior: the storage container 73, 74 the dispensers 70, 71 are therefore hidden behind the front panelling 72. Due to the sideways attaching of the dispensers 70, 71 between the front panelling 72 and the treatment area of the dishwasher, the storage containers 73, 74 extend predominantly for reasons of space along the front panel 72 and have a relatively small depth 75 in the direction of the treatment area, as can be seen in FIGS. 5 and 6. The volumetric capacity of the dispenser 73 for cleaning agent amounts here as well to 1 to 2.5 litres, whilst the dispenser 74 for rinsing agent has a volumetric capacity of 0.5 to 1 litres.

The inlet parts 76, 77 of both dispensers 70, 71 are designed identically. They both feature a handle grip 86, 88 upon which a one-piece inlet that tapers down is formed. The form of the handle grip can be best viewed in FIG. 4, which depicts a cross-section through the dispenser 71 for rinsing agent along the line IV-IV in FIG. 3. The handle grips 86, 88 can both be pulled in and out, together with the respective inlet part 76, 77 on a pivotal axis 90 between the original position, where the handle grips 86, 88 are essentially aligned parallel to the front panelling 72, and the filling position, where the handle grips 86, 88 including the inlets located inside protrude out of the front panelling 72. This can be best viewed in FIGS. 4, 5 and 6, whereby FIG. 5 depicts a top view in accordance with the arrow direction V in FIG. 3 and FIG. 6 shows a cross-section in accordance with the line VI-VI in FIG. 3, where the line VI-VI is located at the height of the pivotal axis 90.

The fact that the inlet part 77 features two channelling surfaces 78, 79 which come together in the area of the pivotal axis 90 can be most clearly seen in FIG. 4 in addition, side restriction surfaces 80, 81 are envisaged, which form the inlet 92 of the inlet part 77 together with the channelling surfaces 78, 79.

For filling, the handle grips 86, 88 are first of all pulled, so that the inlet parts 76, 77 fold out from its original position into the filling position. Then the cleaning of rinsing agent can be poured from above into the respective inlet 92. The rinsing agent poured into the inlet part 77 is fed via the channelling surfaces 78, 79, 80, 81 into a groove 82, which is located in the area of the pivotal axis 90 and is essentially parallel to the pivotal axis 90. The inlet part 76 for cleaning agent also features channelling surfaces and a groove 83 accordingly. The grooves 82, 83 each flow at one end into the respective storage container 73, 74 and are tilted slightly towards this end so that detergent additive is fed sideways into the storage containers 73, 74 via the grooves 82, 83. The location of the rinsing agent dispenser 71 can be best viewed in FIGS. 4 and 6.

In addition, an outlet 94, 96 is envisaged in each storage container 73, 74, via which cleaning or rinsing agent can be dosed out of the respective storage container 73, 74 into the treatment area 6 by means of a doser (not shown). A liquid level display 98, 100 is located in the storage containers 73, 74 in order to register the level of liquid in each of the storage containers 73, 74, which serves to ascertain the liquid level and to signal the need for refilling if necessary.

In FIG. 7 a cross-sectional view of the upper section of a dishwasher in accordance with the invention at hand in line with another design is shown. The following will only address essential differences to the designs shown in FIGS. 1 to 6.

A dispenser 106 is located within the dishwasher housing 102 and above the treatment area 104, where the inlet part 108 takes the form of a drawer. The inlet part 108 is shown in the pulled-out filling position, in which the inlet 110 of the inlet part 108 is accessible from above. Similarly to the inlet part 48, which is shown in FIGS. 1 and 2, channelling surfaces are also envisaged with this inlet part 108, tapering the opening width of the inlet 110 down at the bottom.

A base panel 114 is also envisaged, which channels detergent additive that is poured into the inlet 110 in the direction of a flexible piece of tubing 116. The flexible piece of tubing 116 channels the detergent additive further into a storage container 117, which is located in a fixed position within the dishwasher housing 102. The flexible piece of tubing 116 enables movement of the inlet part 108 (along the arrow direction 118) between the filling position shown and the original position of the inlet part. The handle grip 120, which located on the front side of the inlet part 108, is aligned with the front side 122 of the dishwasher.

FIG. 8 shows a dishwasher that is slightly modified in comparison to that described above, in particular with reference to the types described in FIGS. 1 and 2, and is indicated with the reference number 2′. In addition to a modified loading door 8′, this dishwasher 2′ has a panel 22′ which is attached in a fixed position beneath this door with a section 22a′ in which a cleaning agent dispenser 18′ is able to be pulled out. Its lid 26′ has an upper edge that is pulled somewhat downward and forward over the front wall of the inlet part (not shown), which serves as a handle to pull out the inlet part. If the user lets go of the lid after pulling out the inlet part then this lid will flip automatically by means of spring force into the open position shown in FIG. 8.

In the case of dishwasher 2′, a rinsing agent dispenser with a pull-out drawer 52—in contrast to the design in FIG. 1—is located in a position above and to the right of door 8′. Although a dispenser with an inlet part designed in the form of a drawer or combined inlet part/storage container can also be envisaged to the right or left. The design of the dispenser is taken from now on from the description above, as well as other technical details of the design of the dishwasher 2′.

FIGS. 9 and 10 show another modified dishwasher which is indicated here altogether with the reference number 2″. Only those parts are shown in the figures, which are significant in terms of the modified design, and only these will be described again in the following.

As can be seen in FIG. 9, the dishwasher 2″ has an operating unit 12″ which extends across its entire width, as no dispenser for a detergent additive is envisaged above the door here. Rather, a primary dispenser 14″ for cleaning agent and a secondary dispenser 15″ for rinsing agent is envisaged in the lower, front section of the machine, below the loading door 8″. The front of the dishwasher 2″ is covered in this area with a fixed frontal panelling 22″, which features two identical square sections 22a″ and 22b″ for an inlet part 18″ of the primary dispenser 14″ and a storage container in the same form, at the same time inlet part 19″ of the secondary inlet part 15″.

The parts 18″ and 19″ both have the form of an upright standing cuboid and a spring-loaded lid 26″ or 27″, which opens automatically when pulled out of the front panelling 22″. The upper edges of the lid are, as already seen in the design according to FIG. 8, designed to be protruding and spread, and serve as a handle grip for pulling out.

As shown in the rear view of the front panelling 22″ in FIG. 10, the inlet part 18″ of the primary dispenser 14″ is above a straight synthetic tube 29″, which runs roughly as an extension of a pivotal axis of the inlet part below, linked to the principle of communicating tubes with a storage container 31″, which is filled via the inlet part and the connecting tube 29″ and whose base is located on roughly the same level as the base of the inlet part 18″.

The differentiated design of the storage container 31″ results from issues of space in the base of the dishwasher and is therefore not interrelated to the function of the storage container. The part 19″ of the secondary dispenser can even represent the (only) storage container of this dispenser, whereby tube sockets 19a″ are then attached onto the side wall. A connection to a storage container (similar to the drawer solution in accordance with FIG. 7) can also be realized in the base of the dishwasher. Other tube sockets 19b″ or 26b″ of the parts 19″ or 18″ serve to feed the respective detergent additive into the appropriate cycle.

FIG. 11 shows a modification of the design last described, whereby only those parts are indicated in the figure that are different in design to those in FIG. 10 or are not shown in FIG. 10. Here the lids 33″ or 35″ are concerned, which are attached in a fixed position onto the front panelling 22″ to cover the inlet part in their operating position pushed back into the dishwasher housing (which replace the automatic pull-out lids attached to inlet parts, as in the previously described design).

It can also be seen in FIG. 11 that folded metal strips 22c″ and 22d″ are each envisaged on the side edge of the frontal panel sections 22a″ and 22b″—just as in the previously described design, where the parts could nevertheless not be seen. Suitably formed sections (that are not specifically indicated) of the same panel serve as storage space for the side pivots 18c″ or 19c″ formed on the inlet parts 18″ or 19″.

In an advantageous design corresponding specifically to the design in FIGS. 8 to 11, the pull-out inlet parts are transparent as a result of a see-through surface, either entirely or at least in an adequate section of the front panel of the dishwasher, or they are designed to be translucent enough for the user to be able to recognize the status of the liquid level and therefore to identify the possible need for refilling. This is particularly advantageous when combined with the idea of connecting each respective inlet part with a storage container envisaged within the dishwasher essentially on the same level, in accordance with the principle of communicating tubes, as then the entire supply of detergent additive can be estimated simply by viewing the liquid level in the inlet part.

Dispensers of the dishwasher described above can also feature a mechanical or electronic means (not shown in the figures) of monitoring the liquid level, either as an alternative here or as an extra feature. Float designs are particularly suitable here, for example in connection with a reed contact or other means of registering the float level, devices for measuring the guide value, or other known sensors for monitoring the liquid level in liquid containers. Such devices can optionally be located in storage containers or in the inlet part in the case of dispensers, which feature a storage container and a separate inlet part in fluid connection (and above all with container bases being located on approximately the same level). If the device is located in the inlet part then it is self-evident that suitable measures will be taken to protect sensitive mechanical and/or electronic components from the handling and opening of the inlet part.

The invention is not limited to the designs that have been shown as examples here. Rather the invention results from an expert overall view of the claims, the description, the exemplary designs, and the variations mentioned in the following that are to give an expert references for other alternative designs.

The provision of other components from the initial design, such as a particle sieve, a ventilation opening or a splashguard are particularly advantageous in the case of the designs shown in FIGS. 3 to 7.

A variety of other combinations can also be realized from one or several different dispensers that were shown in FIGS. 1 to 7: for example, just one dispenser 70, 71 can be located in the front panel beneath the loading door and another dispenser 42 in the form of a drawer. In addition, the combination of an external dispenser and a built-in dispenser, as shown in FIGS. 1 to 7, can also be advantageous.

In addition, the pivotal axis of an inlet part can be vertically located so that a sideways movement can be achieved by pulling on the handle.

A spring or tension element can also be envisaged, which preloads the inlet part either in its original position or in its filling position. If, for example, the inlet part is preloaded with a spring into the filling position, a locking mechanism can be envisaged that holds the inlet part in place in its original position. When filling, the locking mechanism can be released either automatically or manually by the user so that the inlet part then moves forward into the filling position by means of spring force. After filling the user must push back the inlet part against the spring force into its original position, until the locking mechanism snaps back into place. Realization is possible with an input tension of the inlet part in the direction of its original position.

The dispenser described can be implemented in different types of dishwashers, for instance in a transport dishwasher with several cycle zones, or in a hood dishwasher as well.

1. Dishwasher, in particular commercial front-opening dishwasher, with at least one dispenser intended for the provision of a liquid detergent additive, whereby the dispenser features a storage container within a dishwasher housing
characterized by the fact that
the at least one dispenser features a separate inlet part in fluid connection with the storage container, which can be pulled or pivoted out of the dishwasher housing into a filling position.

2. Dishwasher in accordance with claim 1
characterized by the fact that
the inlet part features a handle on the front surface of the dishwasher housing and that the respective dispenser can be brought into the filling position by the use of this handle from its original position by moving in relation to the storage container.

3. Dishwasher in accordance with claim 1
characterized by the fact that
the at least one dispenser is designed in the form of a drawer, which can be pulled out of the dishwasher housing into the filling position.

4. Dishwasher in accordance with claim 1
characterized by the fact that
the inlet part is designed in the form of a drawer or embedded pull-out container, which is in fluid connection with the stationary storage container via a tube formation.

5. Dishwasher in accordance with claim 1
characterized by the fact that
at least two dispensers are provided that have inlet parts that are designed in the same way or feature a storage container that can be pulled or pivoted out instead of an inlet part, which is designed in the same way as the inlet part belonging to the other dispenser.

6. Dishwasher in accordance with claim 1
characterized by the fact that
the inlet part of the at least one dispenser can be closed particularly tightly by means of a lid, which opens automatically when the inlet part is pulled or pivoted out and closes automatically when pushed back into the dishwasher housing.

7. Dishwasher in accordance with claim 1
characterized by the fact that
the inlet part of the at least one dispenser is closed particularly tightly in its original position by means of a lid tightly attached behind the front panel.

8. Dishwasher in accordance with claim 1
characterized by the fact that
the at least one dispenser features a splashguard between the storage container and the inlet part through which the cross-sectional flow is tapered down into a flow channel located below.

9. Dishwasher in accordance with claim 1
characterized by the fact that
the dishwasher features a primary dispenser for rinsing agent and a secondary dispenser for cleaning agent.

10. Dishwasher in accordance with claim 9
characterized by the fact that
the primary dispenser is designed in the form of a drawer above the door, whereby the drawer can be pulled forward out of the dishwasher housing into the filling position.

11. Dishwasher in accordance with claim 9
characterized by the fact that
at least the inlet part of the secondary dispenser is located beneath the door of the dishwasher housing.

12. Dishwasher in accordance with claim 11
characterized by the fact that
the inlet parts or a pull-out storage container of the primary or secondary dispenser are located on the front side beneath the door of the dishwasher and that each feature a handle and can be pivoted out into the filling position on a pivotal axis located beneath.

13. Dishwasher in accordance with claim 11
characterized by the fact that
the primary and/or secondary dispenser features a storage container that is built in tightly underneath the door behind the front panel and is connected in particular with its respective inlet part via a tube formation located in the pivotal axis.

14. Dishwasher in accordance with claim 11
characterized by the fact that
the primary and/or secondary dispenser features a storage container tightly built into the lower section of the base of the dishwasher, which is connected most significantly with the respective inlet part via a tube formation.

15. Dishwasher in accordance with claim 1
characterized by the fact that
a liquid level sensor is located in the at least one dispenser, which features in particular a float in connection with a reed contact or a device for measuring the guide value.

16. Dishwasher in accordance with claim 1
characterized by the fact that
the inlet part of the at least one dispenser is connected on essentially the same level with its respective storage container according to the communicating tubes principle and features a means of displaying the entire supply of the relevant detergent additive.

17. Dishwasher in accordance with claim 15
characterized by the fact that
the liquid level sensor is located in the inlet part.

18. Dishwasher in accordance with claim 16
characterized by the fact that
at least one front surface of the inlet part is translucent or transparent and is designed to be seen through from outside in an adapted section of the front panelling of the dishwasher to the extent that the liquid level can be read from the exterior.
